(19) United States
(12) Patent Application Publication
(10) Pub. No.: US 2013/0325544 A1
(43) Pub. Date: Dec. 5, 2013

(54) METHOD FOR MANAGING ENVIRONMENTAL, HEALTH AND SAFETY RISKS IN A MANUFACTURING ENVIRONMENT

(71) Applicants: Stephanie Bonin, Irvine, CA (US); Robert Morton, Tolland, CT (US)

(72) Inventors: Stephanie Bonin, Irvine, CA (US); Robert Morton, Tolland, CT (US)

(73) Assignee: UNITED TECHNOLOGIES CORPORATION, Hartford, CT (US)

(21) Appl. No.: 13/483,267

(22) Filed: May 30, 2012

(51) Int. Cl. G06Q 10/06

(52) U.S. Cl. 705/7.28

(57) ABSTRACT

A method is provided for managing environmental, health and safety (EHS) risks in a manufacturing environment. Risk assessment data received from a first risk assessment database and a second risk assessment database is stored in an EHS risk assessment database. The risk assessment data includes a plurality of first risk assessments and a plurality of second risk assessments for the manufacturing environment. The first risk assessments may be indicative of ergonomic risk assessments, machine guarding risk assessments, industrial hygiene risk assessments, incident investigation risk assessments, or lock-out tag-out risk assessments. The first risk assessments and the second risk assessments are processed to prioritize the risk assessments, and a notification is provided indicative of the prioritized risk assessments.

### BACKGROUND OF THE INVENTION

1. Technical Field

The present invention relates generally to risk management and, in particular, to a method for managing environmental, health and safety risks in a manufacturing environment.

2. Background Information

Environmental, health and safety (EHS) risks in a manufacturing environment may be assessed by trained risk assessors utilizing various manual risk specific assessment methodologies. A first risk assessor, for example, may evaluate an ergonomic risk in the manufacturing environment, and manual score the risk based on a predetermined ergonomic risk assessment scoring standard A second risk assessor may evaluate a machine guarding risk in the manufacturing environment, and manually score the risk based on a predetermined machine guarding risk assessment scoring standard, etc. The risk assessors may input each of the assessed EHS risks into a discrete risk specific database such that the EHS risks may be respectively managed by trained personnel. The ergonomic risk assessment, for example, may be input into an ergonomic risk assessment database, and the machine guarding risk assessment may be input into a separate machine guarding risk assessment database. Utilizing such discrete risk specific databases, however, may impede the generation of a proper general manufacturing environment risk assessment that may account for each different type of EHS risk.

### SUMMARY OF THE DISCLOSURE

According to an aspect of the invention, a method is provided for managing environmental, health and safety (EHS) risks in a manufacturing environment. First risk assessment data received from a first risk assessment database, and second risk assessment data received from a second risk assessment database are stored in an EHS risk assessment database. The first risk assessment data may be indicative of a plurality of first risk assessments for the manufacturing environment such as ergonomic risk assessments, machine guarding risk assessments, industrial hygiene risk assessments, incident investigation risk assessments, or lock-out tag-out risk assessments. The second risk assessment data may be indicative of a plurality of second risk assessments for the manufacturing environment. The first risk assessments and the second risk assessments are processed to prioritize the risk assessments, and a notification is provided indicative of prioritized risk assessments.

In some embodiments, the second risk assessments are different than the plurality of first risk assessments. The second risk assessments include ergonomic risk assessments, machine guarding risk assessments, industrial hygiene risk assessments, incident investigation risk assessments, or lock-out tag-out risk assessments.

In some embodiments, the first risk assessments are normalized, and the processing includes evaluating the plurality of normalized first risk assessments and the plurality of second risk assessments to prioritize the risk assessments. In one embodiment, the second risk assessments are normalized, and the processing includes evaluating the plurality of normalized first risk assessments and the plurality of normalized second risk assessments to prioritize the risk assessments.

In some embodiments, the providing the notification includes sending an email to a predetermined email address regarding a first of the prioritized risk assessments.

In some embodiments, the providing the notification includes sending a text message to a predetermined phone number regarding a first of the prioritized risk assessments.

In some embodiments, the providing the notification includes displaying a first of the prioritized risk assessments on a screen.

In some embodiments, a first of the prioritized risk assessments are reassessed in response to performance of a corrective action to reduce risk in the manufacturing environment associated with the first of the prioritized risk assessments.

In some embodiments, the first risk assessment data is modified based on the second risk assessment data.

In some embodiments, the second risk assessment data is modified based on the first risk assessment data.

In some embodiments, the first risk assessment data is modified based on supplemental data received from a supplemental database. The supplemental data may include one or more or all of the following: legal and regulatory data, monitoring data, objective data, training data, maintenance data, incident response data, design process review data, audit data, evaluation data, and control data. In one embodiment, the second risk assessment data is modified based on the supplemental data. In one embodiment, the supplemental data is modified based on at least one of the first risk assessment data and the second risk assessment data.

In some embodiments, a first risk in the manufacturing environment is assessed using a first risk assessment methodology to provide a first of the plurality of first risk assessments, and the first of the plurality of first risk assessments is input in the first risk assessment database. In one embodiment, a second risk in the manufacturing environment is assessed using a second risk assessment methodology that is different than the first risk assessment methodology to provide a first of the plurality of the second risk assessments, and the first of the plurality of the second risk assessments is input in the second risk assessment database.

The foregoing features and the operation of the invention will become more apparent in light of the following description and the accompanying drawings.

### BRIEF DESCRIPTION OF THE DRAWINGS

FIG. 1 is a system block diagram illustration of an environmental, health and safety risk management system;

FIG. 2 is a flow diagram of a method for managing environmental, health and safety risks in a manufacturing environment; and

FIG. 3 is a system block diagram illustration of another environmental, health and safety risk management system.

### DETAILED DESCRIPTION OF THE INVENTION

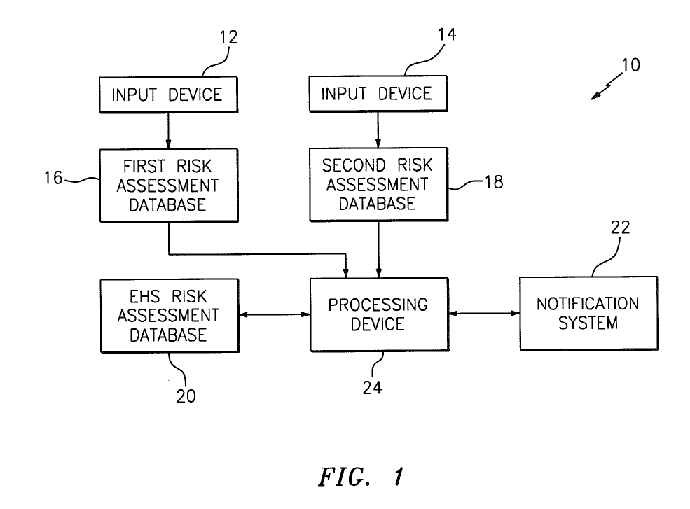

FIG. 1 is a system block diagram illustration of an environmental, health and safety (EHS) risk management system 10. The system 10 may include a plurality of input devices 12 and 14 (e.g., computer terminals, tablets, smart phones, etc.), a plurality of risk assessment databases 16 and 18 (e.g., memory storage devices), an environmental, health and safety (EHS) risk assessment database 20 (e.g., a memory storage device), a notification system 22 (e.g., an email system, a computer terminal, etc.), and a processing device 24 (e.g., a central computer). Each input device 12, 14 is in signal communication (e.g., hardwired or wirelessly connected) with a respective one of the risk assessment databases 16, 18. The processing device 24 is in signal communication with each of the risk assessment databases 16, 18, with the EHS risk assessment database 20, and with the notification system 22.

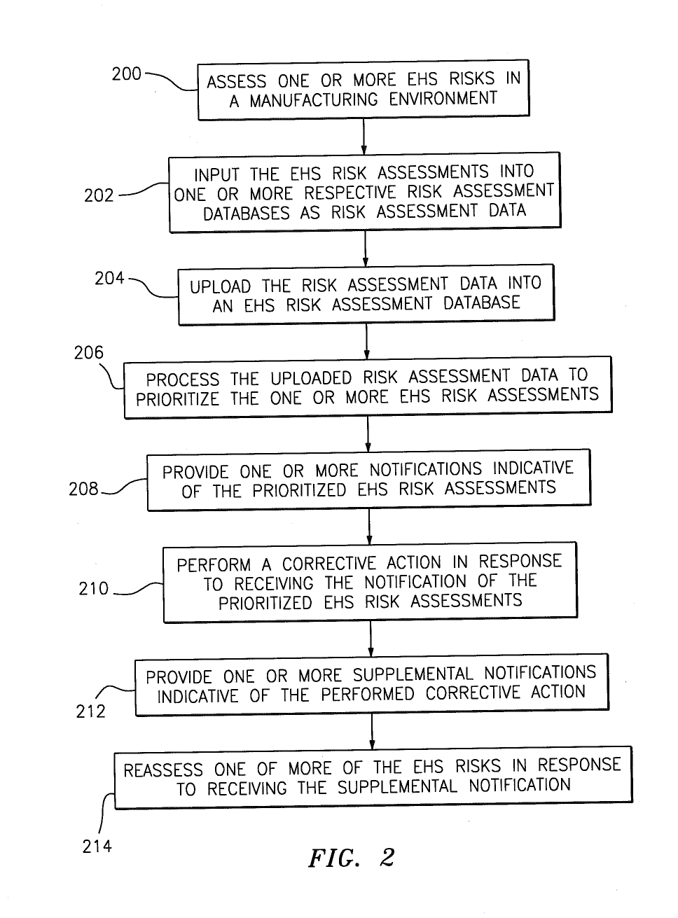

FIG. 2 is a flow diagram of a method for managing environmental, health and safety risks in a manufacturing environment. The term “manufacturing environment” may describe an environment (e.g., one or more factory floors, building and/or worksites) where, for example, turbine engine components and/or systems are machined, cast, formed, welded, coated and/or assembled.

In step 200, one or more environmental, health and safety risks (e.g., hazards) are assessed (e.g., evaluated and scored) in the manufacturing environment. The risks may be associated with, for example, ergonomics, machine guarding, industrial hygiene, incident investigation and/or lock-out tag-out. An ergonomic risk assessment may include, assessing an operator's posture, repetitive motions, amount of force required to accomplish the task, or exposure to vibrations, e.g., an assessment of how many fasteners or clips an operator must manipulate in order to operate a machine located in the manufacturing environment, or the force required to activate a hand tool. A machine guarding risk assessment may include, for example, an assessment of whether a machining device (e.g., multi-axis CNC machine) located in the manufacturing environment has functional or damaged guarding (e.g., blade guards), or whether the guarding is sufficient to prevent or reduce operator injuries. An industrial hygiene risk assessment may include, for example, an assessment of an air particulate level or a noise decibel level within the manufacturing environment. An incident investigation risk assessment may include, for example, an assessment of an injury that occurred in the manufacturing environment, and the cause of the injury. A lock-out tag-out risk assessment may include, for example, an assessment of maintenance personnel's knowledge of safety procedures for disabling (e.g., de-energizing) a machining device prior to performing maintenance on the device in the manufacturing environment. The types of risks assessed in step 200, however, are certainly not limited to the risk assessment examples provided above.

Each type of risk (e.g., ergonomic risk, machine guarding risk, etc.) may be assessed, for example, by a trained risk assessor utilizing a (e.g., risk specific) risk assessment methodology. An ergonomic risk may be assessed, for example, by evaluating and scoring, based on a predetermined set of ergonomics scoring standards, (i) severity of the risk, (ii) frequency at which the risk may occur, (iii) controls utilized to reduce the risk, and (iv) effectiveness of the controls. The ergonomic risk may be quantitatively determined utilizing, for example, the following risk assessment equations:

Ergonomic Risk=Severity Score×Probability; (Eq. 1)

Probability=Frequency Score+Controls Score+Effectiveness Score. (Eq. 2)

In another example, a machine guarding risk may be assessed by qualitatively evaluating and scoring, based on a predetermined set of machine guarding scoring standards, (i) whether a machining device poses an injury risk, (ii) a degree/severity of the injury risk, (iii) whether proper guarding is attached to the machining device to protect workers from the injury risk, etc.

Referring to FIGS. 1 and 2, in step 202, the one or more risk assessments may be respectively input into the risk assessment databases 16 and 18 as risk assessment data utilizing the input devices 12 and 14. An ergonomic risk assessor, for example, may input one or more ergonomic risk assessments into the first risk assessment database 16 (e.g., an ergonomic risk assessment database) utilizing the first input device 12. In another example, a machine guarding risk assessor may input one or more machine guarding risk assessments into the second risk assessment database 18 (e.g., a machine guarding risk assessment database) utilizing the second input device 14.

In step 204, the risk assessment data is uploaded (or received) from the respective risk assessment databases 16 and 18, and stored in the EHS risk assessment database 20. For example, when the one or more ergonomic risk assessments are input into the first risk assessment database 16, the processing device 24 may automatically upload first risk assessment data indicative of the one or more ergonomic risk assessments to the EHS risk assessment database 20 for storage. In another example, when the one or more machine guarding risk assessments are input into the second risk assessment database 18, the processing device 24 may automatically upload second risk assessment data indicative of the one or more machine guarding risk assessments to the EHS risk assessment database 20 for storage. In this manner, the EHS risk assessment database 20 may maintain current (e.g., up-to-date) environmental, health and safety risk assessments for the manufacturing environment.

In step 206, the uploaded risk assessment data is processed in order to prioritize the one or more risk assessments. The processing device 24, for example, may automatically evaluate (e.g., compare) the risk scores for the one or more ergonomic risk assessments and/or the one or more machine guarding risk assessments to provide prioritized risk assessments (e.g., a listing of prioritized EHS risks and scores). A first ergonomic risk assessment with a score of 35, for example, may be assigned a higher priority by the processing device 24 than a second ergonomic risk assessment with a score of 29. In another example, a first machine guarding risk assessment with a score of 32 may be assigned a higher priority by the processing device 24 than a second machine guarding risk assessment with a score of 15. The prioritized risk assessments may therefore include, for example, the first ergonomic risk assessment with the score of 35 and the first machine guarding risk assessment with the score of 32.

In step 208, one or more notifications (e.g., an email, a text message, etc.) are provided indicative of the prioritized risk assessments. The processing device 24, for example, may signal the notification system 22 to send a notification email to a predetermined email address (e.g., an email address for maintenance or repair personnel) regarding the first ergonomic risk assessment and/or the first machine guarding risk assessment. The processing device 24 may also signal the notification system 22 to graphically display the first ergonomic risk assessment and/or the first machine guarding risk assessment on a display screen, for example, for review by risk management staff

In step 210, a corrective action (e.g., machine or building maintenance, cleanup, machine or guarding re-engineering, etc.) may be performed in the manufacturing environment in response to receiving the notification of the prioritized risk assessments. Maintenance personnel, for example, may fix a broken machine guard on a machining device in the manufacturing environment in response to receiving the notification email regarding the first machine guarding risk assessment. The maintenance personnel may also reply to the email notification indicating that the corrective action was performed.

In step 212, one or more supplemental notifications (e.g., an email, a text message, etc.) may be provided indicative of the performed corrective action. The processing device 24, for example, may signal the notification system 22 to send a supplemental notification email to an email address for the machine guarding risk assessor to indicate that a corrective action was performed on the machining device.

In step 214, one or more of the risks are reassessed in response to receiving the supplemental notifications. The machine guarding risk assessor, for example, may reassess the first machine guarding risk in response to receiving the supplemental notification email, and input a new machine guarding risk assessment into the second risk assessment database 18.

In some embodiments, the processing device 24 may normalize the first risk assessment data and/or the second risk assessment data that is respectively received from the first risk assessment database 16 and/or the second risk assessment database 18. The processing device 24, for example, may convert (e.g., translate) the respective risk scores for the ergonomic risk assessments and the machine guarding risk assessments into a common scoring system such that the risk assessments may be compared to one another during step 206. The normalization may also permit system users to use a single risk scoring system.

In some embodiments, the processing device may modify the risk assessment data received from one or more of the risk assessment databases based on other risk assessment data received from another one of the risk assessment databases.

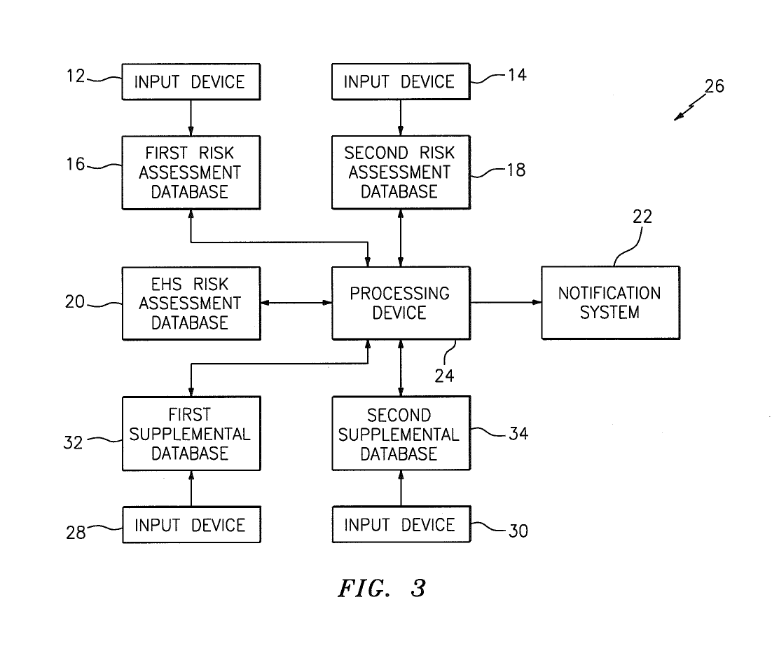

FIG. 3 illustrates another environmental, health and safety (EHS) risk management system 26. In contrast to the system 10 illustrated in FIG. 1, the system 26 may also include one or more second input devices 28 and 30 (e.g., computer terminals, etc.) and one or more supplemental databases 32 and 34 (e.g., memory storage devices, etc.). Each second input device 28, 30 is in signal communication with a respective one of the supplemental databases 32, 34, which are in signal communication with the processing device 24.

During operation, the processing device 24 may receive supplemental data from one or more of the supplemental databases 32 and 34. The supplemental data may be, for example, legal and/or regulatory data, monitoring data, objective (e.g., target) data, training data, maintenance data, incident response data, design process review data, audit data, evaluation data, and/or control data. The legal and/or regulatory data may include, for example, data indicative of state and/or federal environmental, health and safety restrictions to which the manufacturing environment must comply with. The monitoring data may include, for example, data indicative of types and quantities of contaminates in liquids (e.g., water) and/or gases (e.g., air) discharged from the manufacturing environment. The objective data may include, for example, data indicative of company environmental, health and safety standards and goals to which the manufacturing environment should comply with. The training data may include, for example, data indicative of which employees need initial or supplemental training. The maintenance data may include, for example, data indicative of recent maintenance repairs to machines in the manufacturing environment. The incident response data may include, for example, data indicative of how severe a risk actually was based on an actual incident or injury. The design process review data may include, for example, data indicative of modifications made to the machining devices in the manufacturing environment and risks associated with those modifications. The audit data may include, for example, data indicative of compliance with health, safety and/or environmental regulations, etc. The evaluation data may include, for example, data indicative of how well a safety process is being implemented, previously unidentified risks, etc. The control data may include, for example, data indicative of procedures and/or operational controls utilized to reduce risks within the manufacturing environment. The present invention, however, is certainly not limited to the supplemental data examples provided above.

The processing device 24 may utilize the supplemental data to modify the risk assessment data stored in one or more of the risk assessment databases 16 and 18 and/or the EHS risk assessment database 20. The processing device 24 may automatically modify the risk assessment data (e.g., increase a respective risk score) where, for example, the training data indicates that one or more of the employees working in the manufacturing environment is past due for machine safety training In another example, the processing device 24 may modify the machine guarding risk assessment data (e.g., decrease a respective risk score) where, for example, the maintenance data indicates that repairs have recently been made to a machine within the manufacturing environment.

The processing device 24 may alternatively utilize the risk assessment data to modify the supplemental data stored in one or more of the supplemental databases 32 and 34 and/or the EHS risk assessment database 20. The processing device 24 may modify (e.g., update) the maintenance data where, for example, the risk assessment data indicates that a certain risk has been decreased after a reassessment, and maintenance is no longer required.

While various embodiments of the present invention have been disclosed, it will be apparent to those of ordinary skill in the art that many more embodiments and implementations are possible within the scope of the invention. For example, the present invention as described herein includes several aspects and embodiments that include particular features. Although these features may be described individually, it is within the scope of the present invention that some or all of these features may be combined within any one of the aspects and remain within the scope of the invention. Accordingly, the present invention is not to be restricted except in light of the attached claims and their equivalents.

1. A method performed in a processing system for managing environmental, health and safety (EHS) risks in a manufacturing environment, comprising:
storing first risk assessment data received from a first risk assessment database in an EHS risk assessment database, the first risk assessment data comprising a plurality of first risk assessments for the manufacturing environment;
storing second risk assessment data received from a second risk assessment database in the EHS risk assessment database, the second risk assessment data comprising a plurality of second risk assessments for the manufacturing environment;
processing the plurality of first risk assessments and the plurality of second risk assessments with the processing system to prioritize the risk assessments; and
providing a notification indicative of the prioritized risk assessments;
wherein the plurality of first risk assessments comprise one of ergonomic risk assessments, machine guarding risk assessments, industrial hygiene risk assessments, incident investigation risk assessments, and lock-out tag-out risk assessments; and
wherein the plurality of first risk assessments correspond to a first type of EHS risk, and the plurality of second risk assessments correspond to a second type of EHS risk that is different than the first type of EHS risk.

2. The method of claim 1, wherein the plurality of second risk assessments comprise one of ergonomic risk assessments, machine guarding risk assessments, industrial hygiene risk assessments, incident investigation risk assessments, and lock-out tag-out risk assessments.

3. The method of claim 1, further comprising normalizing the plurality of first risk assessments, wherein the processing comprises evaluating the plurality of normalized first risk assessments and the plurality of second risk assessments to prioritize the risk assessments.

4. The method of claim 3, further comprising normalizing the plurality of second risk assessments, wherein the processing comprises evaluating the plurality of normalized first risk assessments and the plurality of normalized second risk assessments to prioritize the risk assessments.

5. The method of claim 1, wherein the providing the notification comprises sending an email to a predetermined email address regarding a first of the prioritized risk assessments.

6. The method of claim 1, wherein the providing the notification comprises sending a text message to a predetermined phone number regarding a first of the prioritized risk assessments.

7. The method of claim 1, wherein the providing the notification comprises displaying a first of the prioritized risk assessments on a screen.

8. The method of claim 1, further comprising reassessing a first of the prioritized risk assessments in response to performance of a corrective action to reduce risk in the manufacturing environment associated with the first of the prioritized risk assessments.

9. The method of claim 1, further comprising modifying the first risk assessment data based on the second risk assessment data.

10. The method of claim 1, further comprising modifying the second risk assessment data based on the first risk assessment data.

11. The method of claim 1, further comprising modifying the first risk assessment data based on supplemental data received from a supplemental database.

12. The method of claim 11, further comprising modifying the second risk assessment data based on the supplemental data.

13. The method of claim 11, wherein the supplemental data comprises at least one of legal and regulatory data, monitoring data, objective data, training data, maintenance data, incident response data, design process review data, audit data, evaluation data, and control data.

14. The method of claim 11, wherein the supplemental data comprises legal and regulatory data, monitoring data, objective data, training data, maintenance data, incident response data, design process review data, audit data, evaluation data, and control data.

15. The method of claim 11, further comprising modifying the supplemental data based on at least one of the first risk assessment data and the second risk assessment data.

16. The method of claim 1, further comprising:
assessing a first risk in the manufacturing environment using a first risk assessment methodology to provide a first of the plurality of first risk assessments; and
inputting the first of the plurality of first risk assessments in the first risk assessment database.

17. The method of claim 16, further comprising:
assessing a second risk in the manufacturing environment using a second risk assessment methodology that is different than the first risk assessment methodology to provide a first of the plurality of the second risk assessments; and
inputting the first of the plurality of the second risk assessments in the second risk assessment database.

18. The method of claim 1, wherein the plurality of first risk assessments comprise ergonomic risk assessments, and the plurality of second risk assessments comprise machine guarding risk assessments.

19. The method of claim 1, wherein the first type of EHS risk and the second type of EHS risk each comprises a respective one of the following types of EHS risks: an ergonomic risk, a machine guarding risk, an industrial hygiene risk, an incident investigation risk, and a lock-out tag-out risk.
